(19) United States
(12) Patent Application Publication
(10) Pub. No.: US 2026/0012756 A1
(43) Pub. Date: Jan. 8, 2026

(54) SIGNALING METHOD FOR BROADCAST NETWORK-BASED RADIO/AUDIO SERVICES AND APPARATUS FOR THE SAME

(71) Applicant: ELECTRONICS AND TELECOMMUNICATIONS RESEARCH INSTITUTE, Daejeon (KR)

(72) Inventors: Jae-Young LEE, Daejeon (KR); Hye-Ju OH, Daejeon (KR); Soon-Choul KIM, Daejeon (KR); Tae-Kyoon KIM, Daejeon (KR); Jae-Hyun SEO, Daejeon (KR)

(73) Assignee: ELECTRONICS AND TELECOMMUNICATIONS RESEARCH INSTITUTE, Daejeon (KR)

(21) Appl. No.: 19/262,267

(22) Filed: Jul. 8, 2025

(30) Foreign Application Priority Data
Jul. 8, 2024 (KR) 10-2024-0089388
Jun. 30, 2025 (KR) 10-2025-0086715

(51) Int. Cl. H04W 4/06

(52) U.S. Cl. CPC H04W 4/06

(57) ABSTRACT

Disclosed herein are a signaling method for broadcast network-based radio/audio services and an apparatus for the same. The signaling method is performed by a transmission apparatus for providing radio/audio services based on a broadcast network, and includes generating an Internet Protocol (IP) packet by encapsulating digital radio/audio content data using Multiplex Distribution Interface (MDI)/Distribution and Communications Protocol (DCP), and generating Service Layer Signaling (SLS) data by modulating the IP packet into an ALP packet, generating a Service List Table (SLT) to set a service protocol signaling value corresponding to the MDI/DCP and generating Low Layer Signaling (LLS) data including the SLT, and transmitting the LLS data and the SLS data.

### CROSS REFERENCE TO RELATED APPLICATIONS

This application claims the benefit of Korean Patent Application Nos. 10-2024-0089388, filed Jul. 8, 2024 and 10-2025-0086715, filed Jun. 30, 2025, which are hereby incorporated by reference in their entireties into this application.

### BACKGROUND OF THE INVENTION

### 1. Technical Field

The present disclosure relates to signaling technology for broadcast network-based radio/audio services, and more particularly to an L2/L3 layer structure and signaling technology for efficient transmission of radio/audio services in broadcast network standards.

### 2. Description of the Related Art

Since the establishment of ATSC 3.0 that is the next-generation broadcast standard, countries such as North and Central America, South Korea, India, and Brazil have either adopted ATSC 3.0 as their national next-generation broadcast standard or are considering its adoption, and the demand for related supplementary services is also increasing.

Accordingly, standardization issues related to digital radio/audio services using broadcast standards are being emphasized, and there is a need to efficiently provide multiple radio/audio services within limited broadcasting resources.

### PRIOR ART DOCUMENTS

### Patent Documents

(Patent Document 1) Korean Patent Application Publication No. 10-2017-0031604, Date of Publication Mar. 21, 2017 (Title: USAC AUDIO SIGNAL ENCODING/DECODING APPARATUS AND METHOD FOR DIGITAL RADIO SERVICES)

### SUMMARY OF THE INVENTION

Accordingly, the present disclosure has been made keeping in mind the above problems occurring in the prior art, and an object of the present disclosure is to provide an L2/L3 layer structure and a signaling method for efficiently transmitting digital radio/audio services based on the ATSC 3.0 broadcast standard.

Another object of the present disclosure is to more efficiently utilize broadcasting resources by reducing Internet Protocol/User Datagram Protocol (IP/UDP) overhead when radio/audio services are provided over a broadcast network.

A further object of the present disclosure is to more rapidly provide radio/audio services through link layer signaling and service level signaling.

In accordance with an aspect of the present disclosure to accomplish the above objects, there is provided a signaling method performed by a transmission apparatus for providing radio/audio services based on a broadcast network, the signaling method including generating an Internet Protocol (IP) packet by encapsulating digital radio/audio content data using Multiplex Distribution Interface (MDI)/Distribution and Communications Protocol (DCP), and generating Service Layer Signaling (SLS) data by modulating the IP packet into an ALP packet; generating a Service List Table (SLT) to set a service protocol signaling value corresponding to the MDI/DCP and generating Low Layer Signaling (LLS) data including the SLT; and transmitting the LLS data and the SLS data.

A signaling value corresponding to the MDI/DCP may be defined in the SLT.

Generating the LLS data may include inputting the signaling value defined to correspond to the MDI/DCP to a service protocol field in the SLT.

The IP packet may be transmitted in accordance with an IPV4 packet or a compressed IP packet.

Transmitting the LLS data and the SLS data may include setting service IDs of a Fast Access Channel (FAC) and a Service Description Channel (SDC) that provide service attribute information in a transmission frame to a service ID of the LLS data.

Transmitting the LLS data and the SLS data may further include transmitting the FAC through a first Physical Layer Pipe (PLP) and transmitting the SDC through a second PLP, wherein the first PLP is set to a channel encoding mode with reception stability higher than that of the second PLP.

In accordance with another aspect of the present disclosure to accomplish the above objects, there is provided a transmission apparatus for providing radio/audio services based on a broadcast network, including a protocol stack including an application layer configured to manage digital radio/audio content data; a transport layer configured to generate an IP packet by encapsulating the digital radio/audio content data using Multiplex Distribution Interface (MDI)/Distribution and Communications Protocol (DCP); a network layer configured to perform routing control on the IP packet; a link layer configured to modulate the IP packet into an ALP packet; and a physical layer configured to transmit the ALP packet, wherein the link layer generates a Service List Table (SLT) to set a service protocol signaling value corresponding to the MDI/DCP, and generates Low Layer Signaling (LLS) data including the SLT.

A signaling value corresponding to the MDI/DCP may be defined in the SLT.

The signaling value defined to correspond to the MDI/DCP may be input to a service protocol field in the SLT.

The IP packet may be transmitted in accordance with an IPV4 packet or a compressed IP packet.

Service IDs of a Fast Access Channel (FAC) and a Service Description Channel (SDC) that provide service attribute information in a transmission frame may be set to a service ID of the LLS data.

The FAC may be transmitted through a first Physical Layer Pipe (PLP) and the SDC is transmitted through a second PLP, wherein the first PLP is set to a channel encoding mode with reception stability higher than that of the second PLP.

In accordance with a further aspect of the present disclosure to accomplish the above objects, there is provided a transmission apparatus for providing radio/audio services based on a broadcast network, including a protocol stack including an application layer configured to manage digital radio/audio content data; a transport layer configured to encapsulate the digital radio/audio content data using Multiplex Distribution Interface (MDI)/Distribution and Communications Protocol (DCP); a link layer configured to convert the encapsulated digital radio/audio content data into an ALP packet; and a physical layer configured to transmit the ALP packet, wherein the ALP packet is transmitted in accordance with packet type extension.

### BRIEF DESCRIPTION OF THE DRAWINGS

The above and other objects, features and advantages of the present disclosure will be more clearly understood from the following detailed description taken in conjunction with the accompanying drawings, in which:

FIG. 1 is a diagram illustrating the protocol stack of the ATSC 3.0 broadcast standard;

FIG. 2 is a diagram illustrating signaling values according to packet types, delivered to an upper layer defined in the ATSC Link-layer Protocol (ALP) of the ATSC 3.0 A/330 standard;

FIG. 3 is an operation flowchart illustrating a signaling method for broadcast network-based radio/audio services according to an embodiment of the present disclosure;

FIG. 4 is a diagram illustrating an example of a protocol stack for digital radio/audio services based on the ATSC 3.0 broadcast standard according to the present disclosure;

FIG. 5 is a diagram illustrating a packet type signaling scheme based on the protocol stack illustrated in FIG. 4;

FIG. 6 is a diagram illustrating an example of service protocol signaling values defined in a Service List Table (SLT) according to the present disclosure;

FIG. 7 is a diagram illustrating another example of a protocol stack for digital radio/audio services based on the ATSC 3.0 broadcast standard according to the present disclosure;

FIG. 8 is a diagram illustrating a packet type signaling scheme based on the protocol stack illustrated in FIG. 7;

FIGS. 9 and 10 are diagrams illustrating examples of service level signaling according to the present disclosure;

FIG. 11 is an operation flowchart illustrating a signaling method for broadcast network-based radio/audio services according to another embodiment of the present disclosure;

FIG. 12 is a diagram illustrating a further example of a protocol stack for digital radio/audio services based on the ATSC 3.0 broadcast standard according to the present disclosure;

FIGS. 13 and 14 are diagrams illustrating a packet type signaling scheme based on the protocol stack illustrated in FIG. 12; and

FIG. 15 is a diagram illustrating a transmission apparatus for providing radio/audio services based on a broadcast network according to an embodiment of the present disclosure.

### DESCRIPTION OF THE PREFERRED EMBODIMENTS

The present disclosure will be described in detail below with reference to the accompanying drawings. Repeated descriptions and descriptions of known functions and configurations which have been deemed to make the gist of the present disclosure unnecessarily obscure will be omitted below. The embodiments of the present disclosure are intended to fully describe the present disclosure to a person having ordinary knowledge in the art to which the present disclosure pertains. Accordingly, the shapes, sizes, etc. of components in the drawings may be exaggerated to make the description clearer.

In the present specification, each of phrases such as “A or B”, “at least one of A and B”, “at least one of A or B”, “A, B, or C”, “at least one of A, B, and C”, and “at least one of A, B, or C” may include any one of the items enumerated together in the corresponding phrase, among the phrases, or all possible combinations thereof.

Hereinafter, embodiments of the present disclosure will be described in detail with reference to the attached drawings.

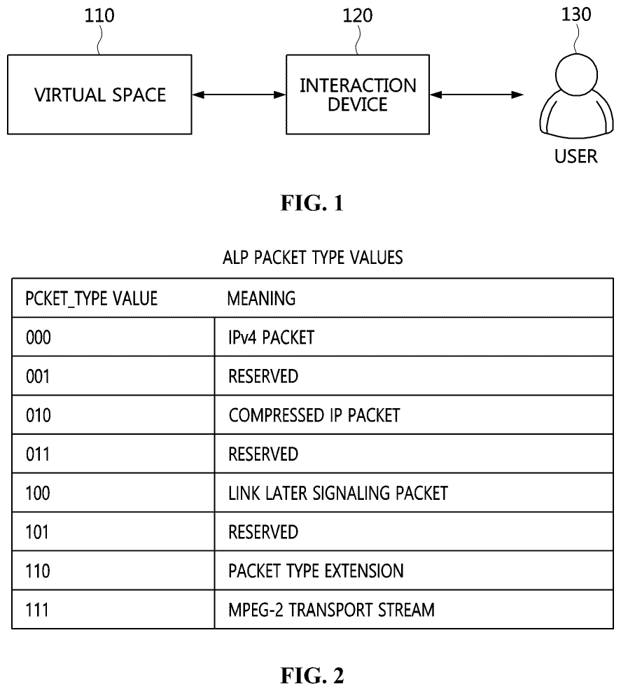

FIG. 1 is a diagram illustrating the protocol stack 100 of the ATSC 3.0 broadcast standard.

Referring to FIG. 1, Audio/Video (A/V) content data produced by a broadcasting company may be packaged in accordance with MPEG Media Transport (MMT) or Real-time Object Delivery over Unidirectional Transport (ROUTE) based on the ATSC 3.0-based A/331 standard, and is transmitted to a terminal through stages such as IP/UDP encapsulation at Layer 3 (L3), ALP encapsulation at Layer 2 (L2) according to the ATSC A/330 standard, and finally a process at a physical layer (Layer 1: L1).

Here, FIG. 2 shows signaling values according to packet types, delivered to an upper layer as defined in ATSC 3.0 Link-layer Protocol (ALP) of the ATSC 3.0 A/330 standard.

Referring to FIG. 2, Internet Protocol version 4 (IPv4) in which a signaling value corresponds to 000 for IP-based transmission is generally used, and the signaling value 001 is reserved for future use of IPV6.

Further, 010 may be signaled to apply Robust Header Compression (ROHC), which is IP header compression technology for reducing IP overhead, and the signaling value 101 may be reserved for a future version of ROHC.

Further, the value 111 may be signaled for the transmission of MPEG-2 Transport Stream (TS) applied in a first-generation broadcast standard, and separate Packet Type Extension with the signaling value 110 is described for the delivery of other services.

Here, assuming that only audio data is utilized as a payload to be transmitted in digital radio/audio services using the ATSC 3.0 standard, IP/UDP header information may consume relatively large transmission resources compared to the audio data payload, thus reducing transmission efficiency.

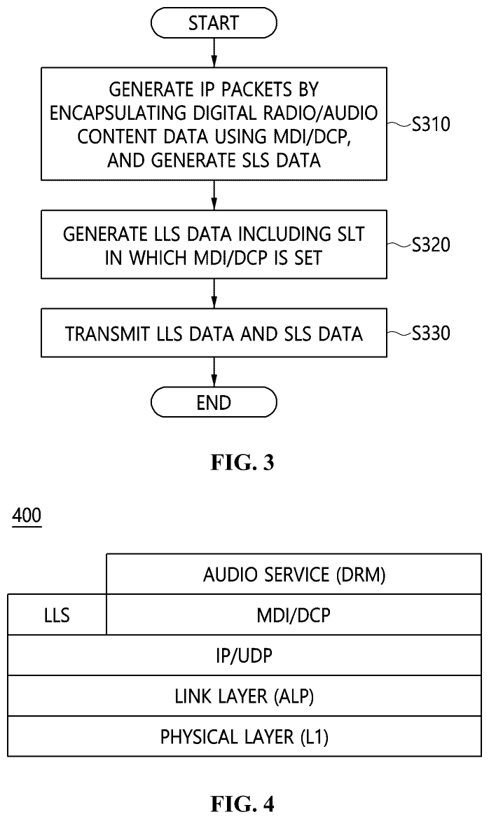

Therefore, in the present disclosure which will be described below with reference to FIGS. 3 to 15, a protocol stack structure and a signaling method for transmitting digital radio/audio services while efficiently utilizing broadcasting resources are proposed.

FIG. 3 is an operation flowchart illustrating a signaling method for broadcast network-based radio/audio services according to an embodiment of the present disclosure.

Referring to FIG. 3, in the signaling method for broadcast network-based radio/audio services according to the embodiment of the present disclosure, a transmission apparatus for providing radio/audio services based on the broadcast network generates IP packets by encapsulating digital radio/audio content data using Multiplex Distribution Interface/Distribution and Communications Protocol (MDI/DCP), and generates Service Layer Signaling (SLS) data by modulating the IP packets into ALP packets at step S310.

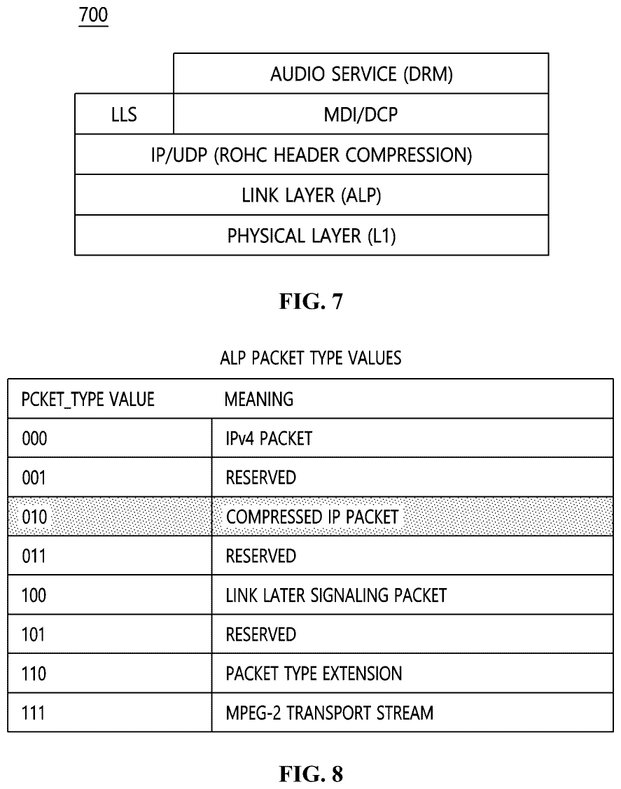

For example, the signaling method illustrated in FIG. 3 may be operated based on a protocol stack 400 or 700 illustrated in FIG. 4 or 7.

Here, the protocol stack 400 or 700 illustrated in FIG. 4 or 7 represents an example of a protocol stack for digital radio/audio services based on the ATSC 3.0 broadcast standard according to the present disclosure, and may signal the digital radio/audio services through the ATSC 3.0 standard-based Service Layer Signaling (SLS).

Here, MDI/DCP may be defined as a packager for transmission in Digital Radio Mondiale standard that is a digital radio standard.

For example, from the standpoint of a server or a base station that provides digital radio/audio services, the digital radio/audio content data may be managed in an application layer forming the protocol stack 400 or 700 through the transmission apparatus. Thereafter, at a transport layer which performs transmission control based on IP addresses, IP packets may be generated by encapsulating the digital radio/audio content data using MDI/DCP.

Here, the IP packets may be transmitted in accordance with IPV4 packets or compressed IP packets.

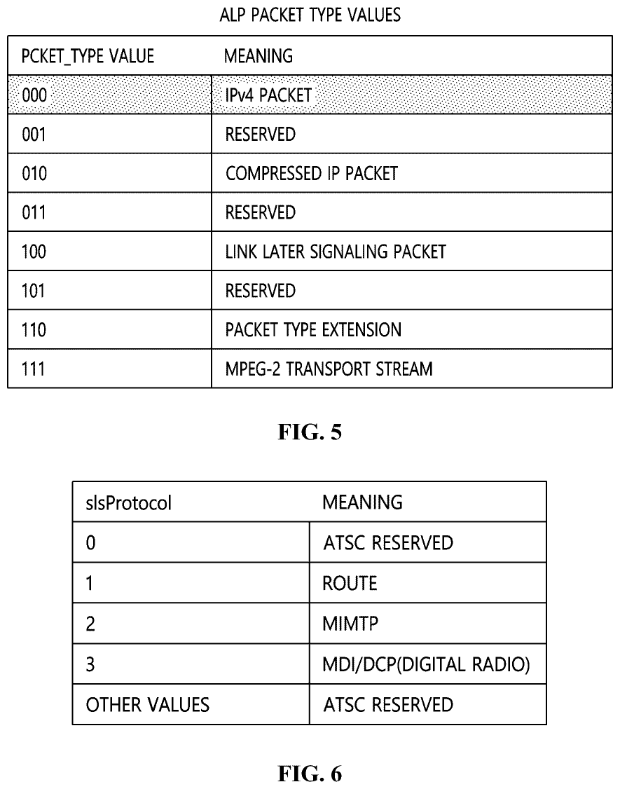

For example, when the protocol stack 400 illustrated in FIG. 4 is applied, an ALP Packet Type Value is signaled as 000 (IPv4), as illustrated in FIG. 5, and thus digital radio/audio services may be provided while the IP/UDP protocol stack may be maintained, as illustrated in FIG. 4.

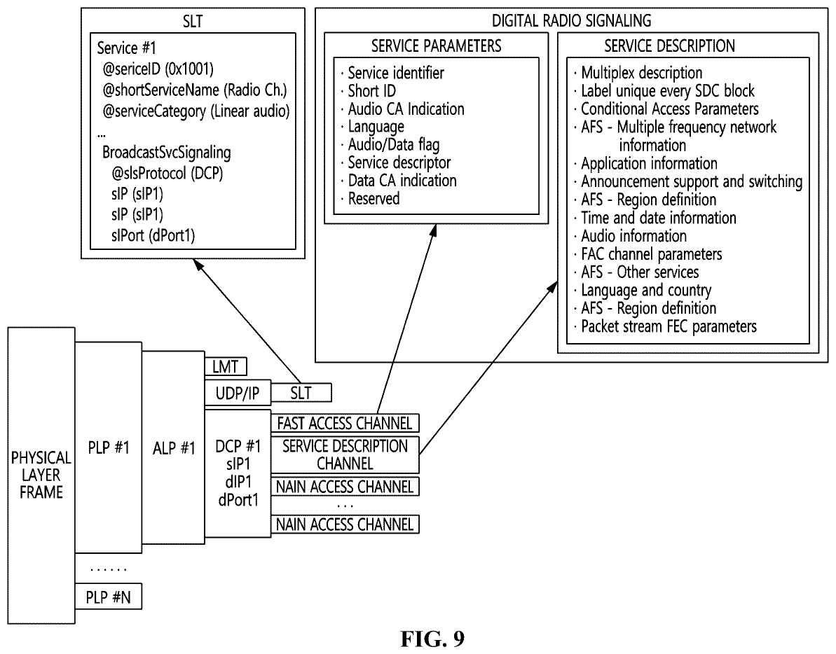

In another example, when the protocol stack 700 illustrated in FIG. 7 is applied, an ALP Packet Type Value is signaled as 010 (indicating a compressed IP packet), as illustrated in FIG. 8, and thus overhead may be reduced through an IP header compression scheme while the IP/UDP protocol stack is maintained, as illustrated in FIG. 7.

The IP packets generated in this way may be routed based on the IP address at the network layer (IP/UDP) of the protocol stack 400 or 700, and may be modulated into ALP packets at the link layer.

Further, in the signaling method for broadcast network-based radio/audio services according to the embodiment of the present disclosure, the transmission apparatus for providing radio/audio services based on the broadcast network sets a service protocol signaling value corresponding to the MDI/DCP by generating a Service List Table (SLT), and generates Low Layer Signaling (LLS) data including the SLT at step S320.

Here, in the SLT, a signaling value corresponding to the MDI/DCP may be defined.

For example, FIG. 6 is a diagram illustrating an example of an SLT for providing digital radio/audio services by applying the protocol stack 400 illustrated in FIG. 4 and FIG. 7.

Referring to the table illustrated in FIG. 6, signaling values of a service protocol delivered through LLS are defined. When a signaling value corresponding to a Service Layer Signaling protocol (slsProtocol) is 1 or 2 (value 1 or value 2), it can be seen that the signaling value follows ROUTE or MMT Packager (MMTP) specifications provided in the existing ATSC 3.0 standard. Here, the present disclosure may newly define a signaling value of 3 (value 3), and may then signal an MDI/DCP packager for digital radio/audio services.

In this case, a signaling value defined to correspond to the MDI/DCP may be input to a service protocol field in the SLT.

Further, in the signaling method for broadcast network-based radio/audio services according to the embodiment of the present disclosure, the transmission apparatus for providing radio/audio services based on the broadcast network transmits the LLS data and the SLS data at step S330.

Here, because the link layer of each of the protocol stacks 400 and 700 illustrated in FIGS. 4 and 7 specifies the digital radio/audio services by providing the SLT through LLS signaling information, faster service acquisition may be performed at a receiver.

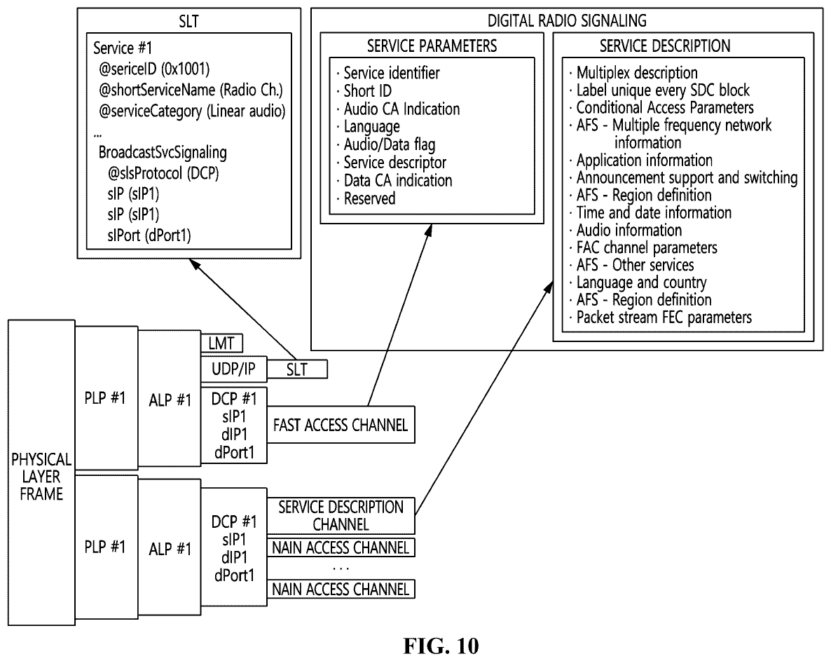

For example, FIGS. 9 and 10 illustrate examples of service level signaling according to the present disclosure, wherein FIG. 9 illustrates an example in which digital radio/audio signaling information is transmitted through a single Physical Layer Pipe (PLP), and FIG. 10 illustrates an example in which digital radio/audio signaling information is divided and transmitted through different PLPs.

First, referring to FIG. 9, it can be seen that a service protocol is set to MDI/DCP (Digital Radio) in an SLT so as to provide digital radio/audio services according to the present disclosure. That is, “SLT.Service.BroadcastSvcSignaling@slsProtocol” may be set to MDI/DCP. In addition, a source IP address (sIP), a destination IP address (dIP), and a destination port number (dPort) of a DCP packet may be set to addresses described in the SLT so that the corresponding service can be found in a digital radio stream through LLS signaling information. Furthermore, service IDs of a Fast Access Channel (FAC) and a Service Description Channel (SDC) which provide service attribute information in a transmission frame may be set to the service ID of the LLS.

In addition, referring to FIG. 10, it can be seen that the receiver divides and transmits digital radio/audio signaling information to different PLPs (i.e., PLP #1 and PLP #2) so that the receiver can rapidly obtain information of the digital radio/audio services. Here, information of a Link Mapping Table (LMT), the SLT, a Fast Access Channel (FAC), or the like may be delivered through the PLP (e.g., PLP #1) set to a channel encoding mode with higher reception stability (i.e., a robust channel encoding mode), and service description information (i.e., Service Description Channel) and a radio main service (i.e., a Main Service Channel) may be delivered through the PLP (e.g., PLP #2) set to another channel encoding mode.

That is, the FAC is transmitted through the first Physical Layer Pipe (PLP) and the SDC is transmitted through the second PLP, but the first PLP may be set to a channel encoding mode with reception stability higher than that of the second PLP.

Through the signaling method for broadcast network-based radio/audio services, efficient digital radio/audio services may be transmitted based on the ATSC 3.0 broadcast standard.

Further, through the LLS and SLS, the radio/audio services may be more rapidly provided.

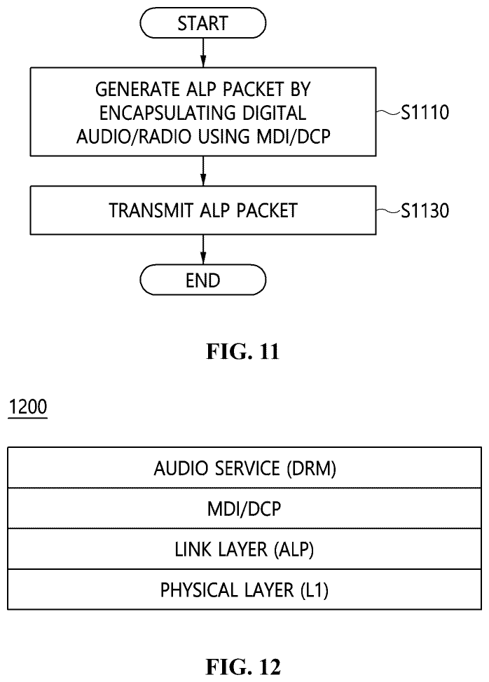

FIG. 11 is an operation flowchart illustrating a signaling method for broadcast network-based radio/audio services according to another embodiment of the present disclosure.

Referring to FIG. 11, in the signaling method for broadcast network-based radio/audio services according to the other embodiment of the present disclosure, a transmission apparatus for providing radio/audio services based on the broadcast network generates ALP packets by encapsulating digital radio/audio content data using Multiplex Distribution Interface/Distribution and Communications Protocol (MDI/DCP) at step S1110, and generates and transmits SLS data including the ALP packets at step S1120.

For example, the signaling method illustrated in FIG. 11 may be operated based on a protocol stack 1200 illustrated in FIG. 12.

Referring to the protocol stack 1200 illustrated in FIG. 12, it can be seen that an IP/UDP layer L3 is omitted by directly signaling digital radio/audio services in accordance with the ALP at a link layer L2. Such a structure is advantageous in that overhead attributable to the use of IP/UDP is reduced.

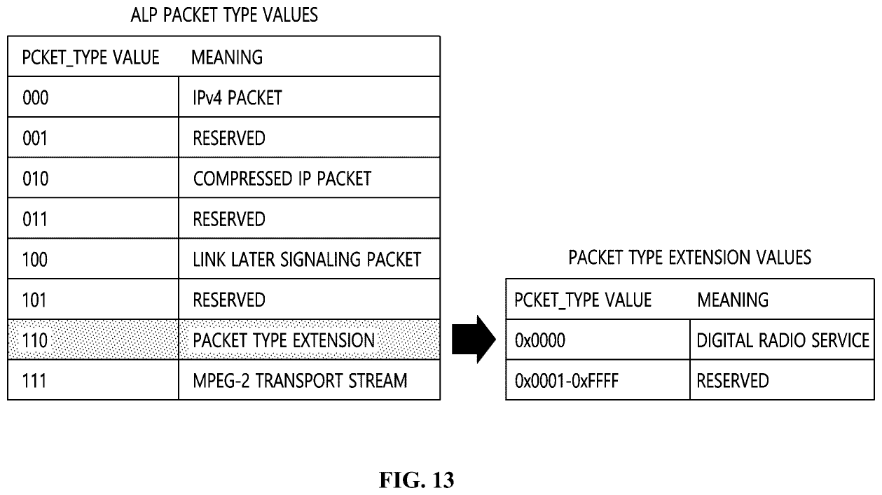

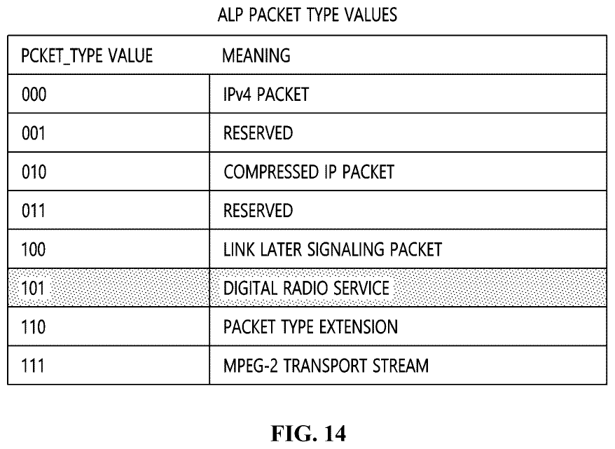

Here, FIGS. 13 and 14 illustrate a package type signaling scheme based on the protocol stack 1200 illustrated in FIG. 12.

For example, when the signaling scheme illustrated in FIG. 13 is used, an ALP Packet Type Value corresponding to digital radio/audio services may be signaled as 110 (indicating Packet Type Extension), and a Digital Radio Mondiale (DRM) standard may be signaled through a Packet Type Extension value of 0x0000. Here, because the Packet Type Extension value may be freely utilized, additional signaling of digital radio standards (e.g., HD Radio, Digital Audio Broadcasting (DAB), DAB+, and the like) other than the DRM standard may also be performed.

In a further example, when the signaling scheme illustrated in FIG. 14 is used, the ALP Packet Type Value 101 may be defined as a digital radio service, and the ALP Packet Type Value corresponding to the digital radio/audio services may be signaled as 101. Such a scheme is advantageous in that, as illustrated in FIG. 13, the usage of signaling bits attributable to the use of the Packet Type Extension 110 may be reduced.

For reference, because 001 defined in the ALP packet type is reserved for IPV6, and 011 is reserved for future version of IP header compression, the signaling value for the utilization of digital radio/audio services may be defined using 101 or 110 (Packet Type Extension).

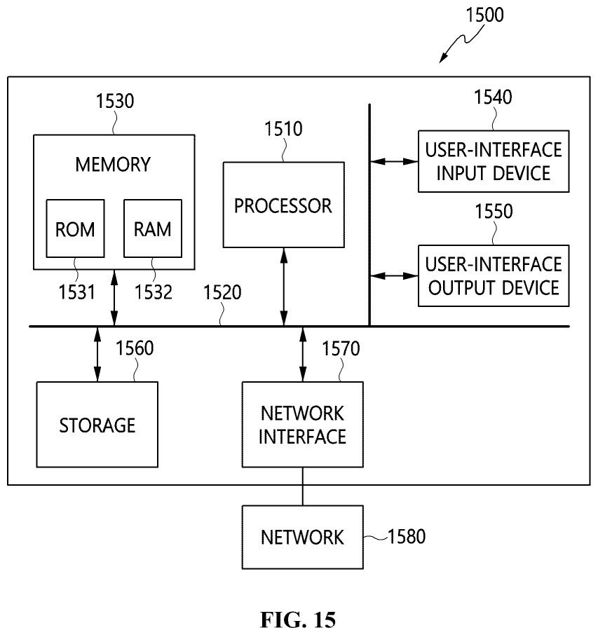

FIG. 15 is a diagram illustrating a transmission apparatus for providing radio/audio services based on a broadcast network according to an embodiment of the present disclosure.

Referring to FIG. 15, the transmission apparatus for providing radio/audio services based on the broadcast network according to the embodiment of the present disclosure may be implemented in a computer system such as a computer-readable storage medium. As illustrated in FIG. 15, a computer system 1500 may include one or more processors 1510, memory 1530, a user input device 1540, a user output device 1550, and a storage 1560, which communicate with each other through a bus 1520. The computer system 1500 may further include a network interface 1570 connected to a network 1580. Each processor 1510 may be a Central Processing Unit (CPU) or a semiconductor device for executing programs or processing instructions stored in the memory 1530 or the storage 1560. Each of the memory 1530 and the storage 1560 may be any of various types of volatile or nonvolatile storage media. For example, the memory 1530 may include Read-Only Memory (ROM) 1531 or Random Access Memory (RAM) 1532.

Therefore, the embodiment of the present disclosure may be implemented as a non-transitory computer-readable medium in which a computer-implemented method or computer-executable instructions are stored. When the computer-readable instructions are executed by the processor, the computer-readable instructions may perform the method according to at least one aspect of the present disclosure.

Here, the transmission apparatus illustrated in FIG. 15 may be operated to include the protocol stack illustrated in FIG. 4, 7 or 12 according to the present disclosure, and may be operated by the signaling method described above with reference to FIG. 3 or 11. Because this has already been described in detail with reference to the previous drawings, further explanation will be omitted.

By utilizing this transmission apparatus, radio/audio services may be more efficiently provided over the broadcast network.

According to the present disclosure, the present disclosure may provide an L2/L3 layer structure and a signaling method for efficiently transmitting digital radio/audio services based on the ATSC 3.0 broadcast standard.

Further, the present disclosure may more efficiently utilize broadcasting resources by reducing Internet Protocol/User Datagram Protocol (IP/UDP) overhead when radio/audio services are provided over a broadcast network.

Furthermore, the present disclosure may more rapidly provide radio/audio services through link layer signaling and service level signaling.

As described above, in the signaling method for broadcast network-based radio/audio services and the apparatus for the signaling method according to the present disclosure, the configurations and schemes in the above-described embodiments are not limitedly applied, and some or all of the above embodiments can be selectively combined and configured such that various modifications are possible.

What is claimed is:

1. A signaling method performed by a transmission apparatus for providing radio/audio services based on a broadcast network, the signaling method comprising:
generating an Internet Protocol (IP) packet by encapsulating digital radio/audio content data using Multiplex Distribution Interface (MDI)/Distribution and Communications Protocol (DCP), and generating Service Layer Signaling (SLS) data by modulating the IP packet into an ALP packet;
generating a Service List Table (SLT) to set a service protocol signaling value corresponding to the MDI/DCP and generating Low Layer Signaling (LLS) data including the SLT; and
transmitting the LLS data and the SLS data.

2. The signaling method of claim 1, wherein a signaling value corresponding to the MDI/DCP is defined in the SLT.

3. The signaling method of claim 2, wherein generating the LLS data comprises:
inputting the signaling value defined to correspond to the MDI/DCP to a service protocol field in the SLT.

4. The signaling method of claim 1, wherein the IP packet is transmitted in accordance with an IPv4 packet or a compressed IP packet.

5. The signaling method of claim 1, wherein transmitting the LLS data and the SLS data comprises:
setting service IDs of a Fast Access Channel (FAC) and a Service Description Channel (SDC) that provide service attribute information in a transmission frame to a service ID of the LLS data.

6. The signaling method of claim 5, wherein transmitting the LLS data and the SLS data further comprises:
transmitting the FAC through a first Physical Layer Pipe (PLP) and transmitting the SDC through a second PLP, wherein the first PLP is set to a channel encoding mode with reception stability higher than that of the second PLP.

7. A transmission apparatus for providing radio/audio services based on a broadcast network, comprising:
a protocol stack comprising:
an application layer configured to manage digital radio/audio content data;
a transport layer configured to generate an IP packet by encapsulating the digital radio/audio content data using Multiplex Distribution Interface (MDI)/Distribution and Communications Protocol (DCP);
a network layer configured to perform routing control on the IP packet;
a link layer configured to modulate the IP packet into an ALP packet; and
a physical layer configured to transmit the ALP packet,
wherein the link layer generates a Service List Table (SLT) to set a service protocol signaling value corresponding to the MDI/DCP, and generates Low Layer Signaling (LLS) data including the SLT.

8. The transmission apparatus of claim 7, wherein a signaling value corresponding to the MDI/DCP is defined in the SLT.

9. The transmission apparatus of claim 8, wherein the signaling value defined to correspond to the MDI/DCP is input to a service protocol field in the SLT.

10. The transmission apparatus of claim 7, wherein the IP packet is transmitted in accordance with an IPV4 packet or a compressed IP packet.

11. The transmission apparatus of claim 7, wherein service IDs of a Fast Access Channel (FAC) and a Service Description Channel (SDC) that provide service attribute information in a transmission frame are set to a service ID of the LLS data.

12. The transmission apparatus of claim 11, wherein the FAC is transmitted through a first Physical Layer Pipe (PLP) and the SDC is transmitted through a second PLP, wherein the first PLP is set to a channel encoding mode with reception stability higher than that of the second PLP.

13. A transmission apparatus for providing radio/audio services based on a broadcast network, comprising:
a protocol stack comprising:
an application layer configured to manage digital radio/audio content data;
a transport layer configured to encapsulate the digital radio/audio content data using Multiplex Distribution Interface (MDI)/Distribution and Communications Protocol (DCP);
a link layer configured to convert the encapsulated digital radio/audio content data into an ALP packet; and
a physical layer configured to transmit the ALP packet,
wherein the ALP packet is transmitted in accordance with packet type extension.
